(19) United States
(12) Patent Application Publication
(10) Pub. No.: US 2025/0155276 A1
(43) Pub. Date: May 15, 2025

(54) OPTICAL FIBER ACOUSTIC SENSOR WITH IMPROVED ACOUSTIC SIGNAL MEASUREMENT SENSITIVITY

(71) Applicant: KOREA PHOTONICS TECHNOLOGY INSTITUTE, Gwangju (KR)

(72) Inventors: Myoung Jin KIM, Gwangju (KR); Joo Young LEE, Jeollanam-do (KR); Young Ho KIM, Gwangju (KR); Hui Oon KIM, Gwangju (KR); Hyo Jong KIM, Gwangju (KR); Hyo Young JUNG, Suwon-si (KR)

(21) Appl. No.: 18/274,016

(22) PCT Filed: Sep. 22, 2022
(86) PCT No.: PCT/KR2022/014159

§ 371 Date: Jan. 22, 2025

(30) Foreign Application Priority Data
Jun. 28, 2022 (KR) 10-2022-0079110

(51) Int. Cl. G01H 9/00; G01D 5/353

(52) U.S. Cl. CPC G01H 9/004; G01D 5/35361

(57) ABSTRACT

The present invention relates to an optical fiber acoustic sensor with improved acoustic signal measurement sensitivity, and includes: a light source unit that generates and outputs pulsed light; an optical circulator that outputs the pulsed light output from the light source unit and input to an input terminal through an output terminal, and outputs light incident reversely from the output terminal through a detection terminal; a sensing optical fiber connected to the output terminal of the optical circulator and installed to extend over a measurement target region; at least one acoustic focusing member having the sensing optical fiber wound thereon multiple times, arranged in a measurement target region and adapted to focus an external acoustic signal; a light detection unit that detects Rayleigh scattered light scattered in the sensing optical fiber and traveling reversely; and a signal processing unit that control generation of the pulsed light by the light source unit and measures a vibration frequency and an intensity of acoustic received through the sensing optical fiber from a signal detected by the light detection unit, based on an output time point of the pulsed light.

### TECHNICAL FIELD

The present invention relates to an optical fiber acoustic sensor, and more particularly, to an optical fiber acoustic sensor capable of improving acoustic signal measurement sensitivity.

### BACKGROUND ART

Various distributed optical fiber sensors for which an optical fiber is installed and operated over a long distance of around 10 km are disclosed, such as Korean Registration Patent No. 10-1223105.

The distributed optical fiber sensor measures the intensity of back-scattered light in the optical fiber, which is reflected differently and returned depending on a physical quantity acting on a specific position of the optical fiber cable, by using a scattering phenomenon in the optical fiber, and can be configured to detect various physical quantities such as strain, in addition to temperatures.

Among the distributed optical fiber sensors, there is known an optical fiber acoustic sensor using Rayleigh scattering (DAS: Distributed Acoustic Sensor).

The optical fiber acoustic sensor is a sensor that measures scattered light generated from light traveling inside the optical fiber due to a non-uniform distribution of a density of the optical fiber, and can obtain back-scattered light proportional to the intensity of pulsed light. Such an optical fiber acoustic sensor is proposed in Korean Registration Patent No. 10-1817295, for example.

Meanwhile, the distributed optical fiber acoustic sensor of the related art has such a structure that a sensing optical fiber is simply laid along a measurement target region, making it difficult to efficiently measure the measurement target acoustic when it is weak. Therefore, there is a need for a structure capable of improving measurement sensitivity.

### DETAILED DESCRIPTION OF THE INVENTION

### Technical Problem

The present invention has been made to solve the above requirements, and an object thereof is to provide an optical fiber acoustic sensor capable of improving acoustic signal measurement sensitivity so that weak acoustic signals can also be easily measured.

### Technical Solution

In order to achieve the above object, an optical fiber acoustic sensor according to the present invention includes a light source unit configured to generate and output pulsed light in response to a control signal; an optical circulator configured to output the pulsed light output from the light source unit and input to an input terminal through an output terminal, and to output light incident reversely from the output terminal through a detection terminal; a sensing optical fiber connected to the output terminal of the optical circulator and installed to extend over a measurement target region; at least one acoustic focusing member having the sensing optical fiber wound thereon multiple times, arranged in a measurement target region and configured to focus an external acoustic signal; a light detection unit configured to detect Rayleigh scattered light scattered in the sensing optical fiber and traveling reversely; and a signal processing unit configured to control generation of the pulsed light by the light source unit and to measure a vibration frequency and an intensity of acoustic received through the sensing optical fiber from a signal detected by the light detection unit, based on an output time point of the pulsed light.

According to one aspect of the present invention, the acoustic focusing member is applied as a conical antenna formed in a cup shape having an inner diameter gradually decreasing from an upper part where an opening is formed toward a lower part, and the sensing optical fiber is wound on an outer side of the lower part of the conical antenna spaced apart from the opening.

According to another aspect of the present invention, the acoustic focusing member is applied as a focusing antenna formed in an elliptical or parabolic shape for reflecting and focusing acoustic incident from the outside to a focal point, and the sensing optical fiber is wound multiple times on a sensing part provided at the focal point of the focusing antenna.

### Advantageous Effects

According to the optical fiber acoustic sensor of the present invention, since the sensing optical fiber is configured to react to the focused acoustic signal, it is possible to improve measurement sensitivity to the acoustic signal.

### BRIEF DESCRIPTION OF DRAWINGS

FIG. 1 is a view showing an optical fiber acoustic sensor according to the present invention.

FIG. 2 is a perspective view showing a conical antenna of FIG. 1.

FIG. 3 is a partially cut side view showing a focusing antenna according to another embodiment of the present invention.

### BEST MODE

Hereinafter, an optical fiber acoustic sensor according to preferred embodiments of the present invention will be described in more detail with reference to the accompanying drawings.

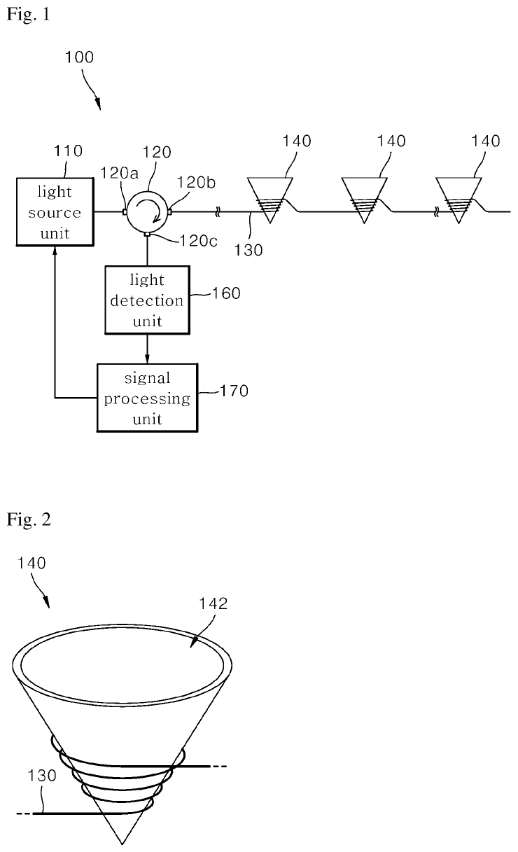

FIG. 1 is a view showing an optical fiber acoustic sensor according to the present invention, and FIG. 2 is a perspective view showing a conical antenna of FIG. 1.

Referring to FIGS. 1 and 2, an optical fiber acoustic sensor 100 according to the present invention includes a light source unit 110, an optical circulator 120, a sensing optical fiber 130, a conical antenna 140, a light detection unit 160, and a signal processing unit 170.

The light source unit 110 generates and outputs pulsed light in response to a control signal of the signal processing unit 170. The light source unit 110 may be configured by a pulse generator (not shown) for generating pulses in response to a driving control signal of the signal processing unit 170 and a light source (not shown) for outputting pulsed light according to the pulses output from the pulse generator.

In addition, of course, the light source unit 110 may be configured to provide part of the generated pulsed light to the signal processing unit 170 so as to perceive a generation time point of the pulsed light.

The optical circulator 120 outputs the pulsed light output from the light source unit 110 and input to an input terminal 120a through an output terminal 120b, and outputs light incident reversely from the output terminal 120b through a detection terminal 120c.

The sensing optical fiber 130 has one end connected to the output terminal 120b of the optical circulator 120, is installed to extend in series over a measurement target area, and is installed in a pattern of being wound multiple times on the conical antenna 140 and extending in series, in a sensitivity improvement measurement region.

A plurality of the conical antennas 140 each having the sensing optical fiber 130 wound thereon multiple times are arranged spaced apart from each other in the measurement target region, and are each applied as an acoustic focusing member capable of focusing external acoustic signals.

The conical antenna 140 is formed in a cup shape having an inner diameter gradually decreasing from an upper part where an opening is formed toward a lower part and a closed lower end. The sensing optical fiber 130 is closely wound multiple times on an outer side of the lower part spaced apart from the opening 142 of the conical antenna 140.

The conical antenna 140 is configured such that the external acoustic is focused while traveling downward from the opening, and the sensing optical fiber 130 wound multiple times on the lower part increases the efficiency of generation of Rayleigh scattered light by the focused acoustic, thereby improving measurement sensitivity.

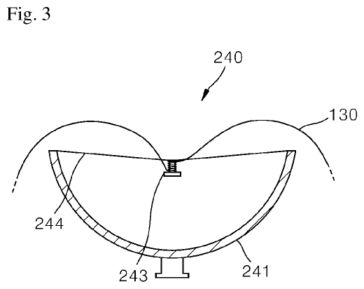

Meanwhile, an acoustic focusing structure having a structure different from the shown conical antenna 140 as an acoustic focusing member for focusing acoustic signals may be applied, and an example thereof will be described with reference to FIG. 3.

Referring to FIG. 3, a focusing antenna 240 is applied as the acoustic focusing member.

The focusing antenna 240 includes a reflection part 241 formed in an elliptical or parabolic shape for reflecting and focusing acoustic incident from the outside toward a focal position and a sensing part 243 provided at the focal position of the reflection part 241, and the sensing part 243 is supported by a plurality of support lines 244 extending from the reflection part 241 toward the focal position.

The sensing optical fiber 130 is wound multiple times on the sensing part 243.

In such a focusing antenna 240, the acoustic incident from the outside is reflected on the reflection part 241 and focused on the sensing part 243, and the sensing optical fiber 130 wound multiple times on the sensing part 243 increases the efficiency of generation of Rayleigh scattered light by the focused acoustic, thereby improving measurement sensitivity.

The light detection unit 160 is connected to the detection terminal 120c of the optical circulator 120, detects Rayleigh scattered light scattered in the sensing optical fiber 130, traveling reversely and output from the detection terminal 120c, and provides a signal corresponding to the detected light to the signal processing unit 170.

For the light detection unit 160, a wavelength filter for filtering only Rayleigh scattered light scattered in the sensing optical fiber 130, traveling reversely and output from the detection terminal 120c and outputting the light as an electrical signal may be applied.

The signal processing unit 170 controls the light source unit 110 so that pulsed light is generated from the light source unit 110. The signal processing unit 170 measure, for each position, a vibration frequency and an intensity of acoustic received through the sensing optical fiber 130 from a signal detected by the light detection unit 160, based on an output time point of the pulsed light from the light source unit 110.

According to the optical fiber acoustic sensor described above, since the sensing optical fiber is configured to react to the focused acoustic signal, it is possible to improve measurement sensitivity to the acoustic signal.

1. An optical fiber acoustic sensor comprising:
a light source unit configured to generate and output pulsed light in response to a control signal;
an optical circulator configured to output the pulsed light output from the light source unit and input to an input terminal through an output terminal, and to output light incident reversely from the output terminal through a detection terminal;
a sensing optical fiber connected to the output terminal of the optical circulator and installed to extend over a measurement target region;
at least one acoustic focusing member having the sensing optical fiber wound thereon multiple times, arranged in a measurement target region and configured to focus an external acoustic signal;
a light detection unit configured to detect Rayleigh scattered light scattered in the sensing optical fiber and traveling reversely; and
a signal processing unit configured to control generation of the pulsed light by the light source unit and to measure a vibration frequency and an intensity of acoustic received through the sensing optical fiber from a signal detected by the light detection unit, based on an output time point of the pulsed light.

2. The optical fiber acoustic sensor according to claim 1, wherein the acoustic focusing member is applied as a conical antenna formed in a cup shape having an inner diameter gradually decreasing from an upper part where an opening is formed toward a lower part, and the sensing optical fiber is wound on an outer side of the lower part of the conical antenna spaced apart from the opening.

3. The optical fiber acoustic sensor according to claim 1, wherein the acoustic focusing member is applied as a focusing antenna formed in an elliptical or parabolic shape for reflecting and focusing acoustic incident from the outside toward a focal point, and the sensing optical fiber is wound multiple times on a sensing part provided at the focal point of the focusing antenna.
